(19) United States
(12) Patent Application Publication
(10) Pub. No.: US 2021/0235665 A1
(43) Pub. Date: Aug. 5, 2021

(54) PET WATER BOTTLE

(71) Applicant: Clarice Brown, Neptune, NJ (US)

(72) Inventor: Clarice Brown, Neptune, NJ (US)

(21) Appl. No.: 16/777,134

(22) Filed: Jan. 30, 2020

(51) Int. Cl. A01K 7/00; B65D 1/02; B65D 23/10; A45F 3/18

(52) U.S. Cl. CPC A01K 7/005; A45F 3/18; B65D 23/102; B65D 1/02

(57) ABSTRACT

A portable drinking system for canines in the shape of a water bottle. The hollow outer molded water bottle casing splits lengthwise down the middle along the hinges, and is held together by clasps when in a closed position. The back half has two roll stops to hold the back half stable on a flat surface so that the back half can be filled with water bottle. One or more bottle pinches located inside the molder water bottle casing can hold a reusable bottle in place. The reusable bottle can be filled with water in advance, and even frozen, to provide a refreshing supply of cool water when away from home. The portable drinking system for canines provides a practical means of providing dogs and other pets with replenishing water when out on walks, traveling, or otherwise on the go.

### BACKGROUND OF THE INVENTION

### 1. Field of the Invention

The present invention relates generally to the field of portable water bottle drinking systems and devices for canines, and more specifically relates to a specially designed, portable storage device in the shape of a water bottle, which may contain within a reusable water bottle. Split lengthwise down the middle, one half of the bottle shaped casing would fold downward to create a pet water dish that can be filled by the contained water bottle. Design intent is to provide a practical means of providing dogs and other pets with replenishing water when out on walks, traveling, or otherwise on the go.

### 2. Description of the Related Art

Perhaps nothing is more enjoyable for dogs than going on a brisk walk with their owners. Whether sniffing in all the interesting smells of the outside, running into fellow canine friends, or simply feeling the sun on their bodies, walking for dogs provides them with amusement, exercise, and energy release. Jogging along with their owner or running freely through a park often results in dogs becoming very thirsty, especially on hot days. To avoid dehydration, dogs require plenty of water, as much if not more so than humans. Since it is often not practical to take a pet's water bowl along while out walking, pet owners are often faced with the daunting if not impossible task of finding a convenient method of supplying their dog with fresh water when engaged in a walk, jog or even when spending time away from home.

Often times, one will attempt to pour some water from their own water bottle into their hand in attempts to create a makeshift bowl out of which the dog can drink. An awkward solution at best, pouring water into the hand often results in the majority of the water spilling to the ground below, hardly quenching an animal's thirst. Looking to satisfy its thirst, a dog will drink out of virtually any available water source regardless of whether it is sanitary or not. As can be imagined, attempting to prevent a thirsty pooch from drinking from a dirty mud puddle or other suspect water source can be a challenge for dog owners, particularly as most are especially concerned with the safety and health of their pet. As such, an improved means to transport and supply clean potable water for a pet is needed.

Various attempts have been made to solve problems found in portable pet hydration art. Among these are found in: U.S. Pat. No. 8,272,351 to Marni Markell Hurwitz; U.S. Pat. No. 5,960,742 to O'Rourke et al.; and U.S. Pat. No. 7,490,577 to Prodromos Pericles Stephanos. This prior art is representative of portable water bottle drinking systems and devices for canines.

None of the above inventions and patents, taken either singly or in combination, is seen to describe the invention as claimed. Thus, a need exists for a reliable Pet Water Bottle, a specially designed, portable storage device in the shape of a water bottle, which may contain within a reusable water bottle. Split lengthwise down the middle, one half of the bottle shaped casing would fold downward to create a pet water dish that can be filled by the contained water bottle to provide a practical means of providing dogs and other pets with replenishing water when out on walks, traveling, or otherwise on the go, and to avoid the above-mentioned problems.

### BRIEF SUMMARY OF THE INVENTION

In view of the foregoing disadvantages inherent in the known portable pet hydration systems art, the present invention provides a novel Pet Water Bottle. The general purpose of the present invention, which will be described subsequently in greater detail, is to provide a specially designed, portable storage device in the shape of a water bottle, which may contain within a reusable water bottle. Split lengthwise down the middle, one half of the bottle shaped casing would fold downward to create a pet water dish that can be filled by the contained water bottle. Design intent is to provide a practical means of providing dogs and other pets with replenishing water when out on walks, traveling, or otherwise on the go. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, Pet Water Bottle, constructed and operative according to the teachings of the present invention.

FIG. 1 shows a perspective view illustrating a front side of a Pet Water Bottle according to an embodiment of the present invention.

FIG. 2 shows a perspective view illustrating a back side of the Pet Water Bottle according to an embodiment of the present invention.

FIG. 3 shows a perspective view illustrating the inside of the Pet Water Bottle according to an embodiment of the present invention.

FIG. 4 shows a perspective view illustrating the Pet Water Bottle with a removable internal water bottle according to an embodiment of the present invention.

The various embodiments of the present invention will hereinafter be described in conjunction with the appended drawings.

### DETAILED DESCRIPTION

As discussed above, embodiments of the present invention relate to a portable water bottle drinking systems and devices for canines. and more particularly to a Pet Water Bottle, a specially designed, portable storage device in the shape of a water bottle, which may contain within a reusable water bottle. Split lengthwise down the middle, one half of the bottle shaped casing would fold downward to create a pet water dish which can be filled by the contained water bottle. Design intent is to provide a practical means of providing dogs and other pets with replenishing water when out on walks, traveling, or otherwise on the go.

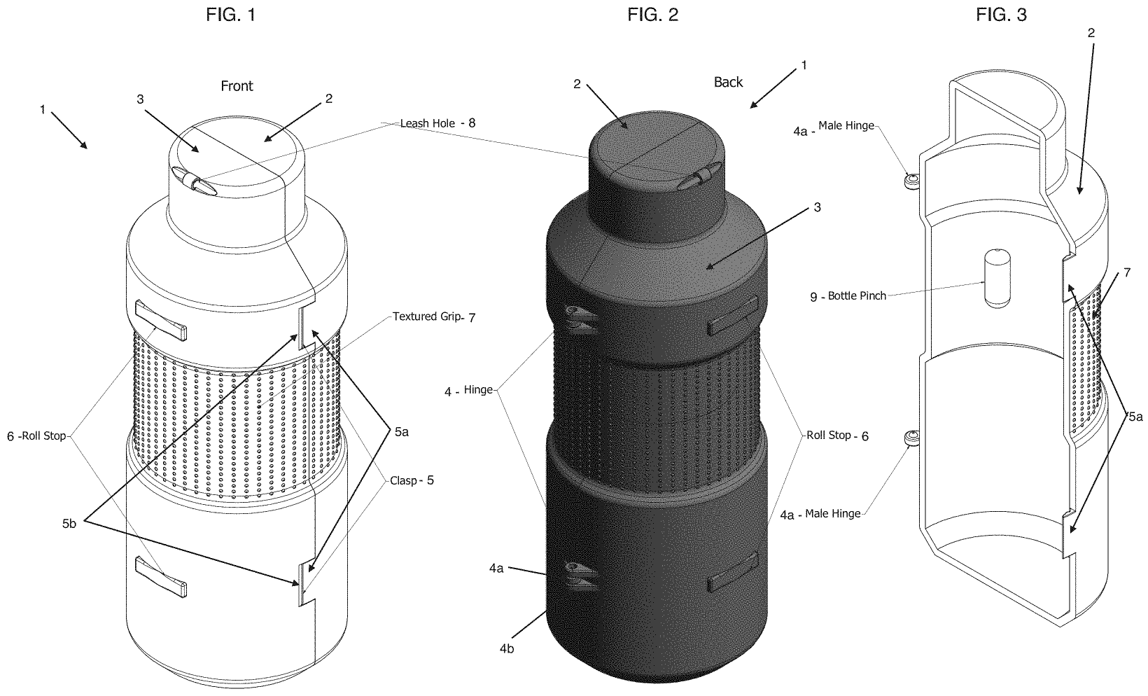

Referring now to the drawings FIGS. 1-4, the Pet Water Bottle comprising a novel product offering consumers a practical solution to the aforementioned challenges. As the name implies, the Pet Water Bottle is a specially designed portable storage device formed from a molded pet dish that that can house a similarly shaped reusable water bottle. The pet water bottle provides caring pet owners a practical means of providing their dog replenishing water when out on walks or otherwise on the go.

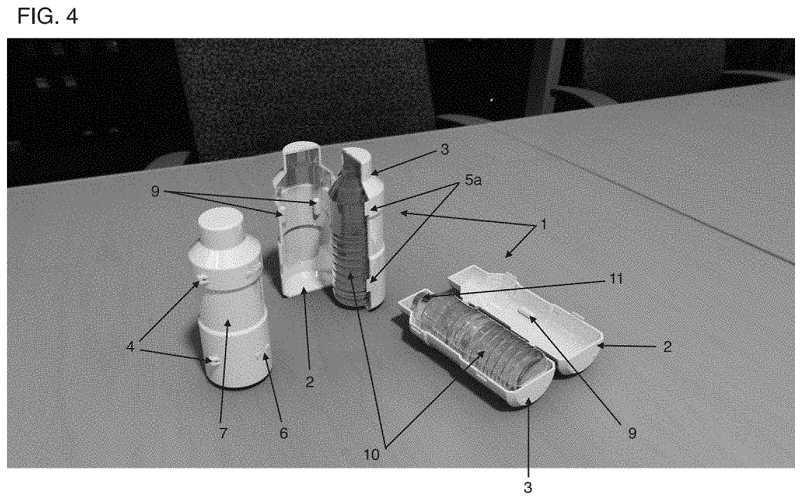

The Pet Water Bottle may be comprised of two main components: the water bottle 10 and the water reservoir 1, both of which may be manufactured of heavy duty yet lightweight PBA-free plastic material. As shown in FIG. 4, the water bottle 10 itself may be cylindrical shaped receptacle sized appropriately to hold at least one half a liter of liquid.

The water bottle of the Pet Water Bottle may feature a narrow neck culminating in a removable, leak-proof threaded lid, attached to the bottle via a sturdy plastic tether.

As shown in FIGS. 1-2, the molded pet dish 1 splits lengthwise down the middle to form a front side 2 and a back side 3. The front 2 and the back 3 are connected together on one side by a set of hinges 4. The front part 2 has two male hinges 4a while the back part 3 has two female hinges 4b. On the other side, the front part 2 and the back part 3 are held together by two clasps 5. Each clasp has a lock portion 5a and a catch portion 5b, arranged so that the lock portion is held in place by the catch portion when the clasps are closed.

The back part 3 of the bottle shaped casing has two roll stops 6 that allow it to rest in a stable manner on the ground without rolling or tipping, allowing the back part 3 to function as a pet dish. Both the front 2 and the back 3 have a connecting, textured middle section 7, forming a textured grip 7 to reduce the likelihood of a pet owner dropping the molded casing 1.

The top of the back part 3 has a leash hole 8. The leash hole 8 is sized to allow a leash to be slipped through it so the molded casing 1 can be carried on the leash instead of in the pet owner's hands or bag.

As shown in FIGS. 3-4, the interior of the water reservoir 1 has a bottle pinch 9 that is molded to abut flush against a water bottle 10 lengthwise. The bottle pinch 9 holds the reusable water bottle 10 in place inside the molded water bottle casing 1 so that the reusable water bottle 10 does not jostle about while a pet owner is walking his/her dog.

The Pet Water Bottle 1 may be offered in a wide variety of vibrant colors, as well as standard neutral hues. As shown in FIG. 4, the pet water bottle 1 may include a reusable water bottle 10 with a removable lid 11 that is similarly shaped to the outer casing so that it fits readily inside the molded casing. Both the water resevoir 1 and the reusable water bottle 10 are freezable, so a user may choose to store the unit in their refrigerator freezer, thus providing icy cold refreshment to their pet when out and about.

The Pet Water Bottle 1 may offer a convenient means of providing water to pets while out on walks or otherwise on the go. Quenching an active animal's thirst, the Pet Water Bottle may prevent possible dehydration on hot and dry days. A practical alternative to awkwardly pouring water directly into the hand in order to present it to a dog, or worse, allowing the animal to drink from a dirty water puddle, the Pet Water Bottle may provide an ample, sanitary receptacle from which the animal could comfortably drink.

The compact design and included strap of the unit facilitates portability, as well as an easy hold, allowing the Pet Water Bottle to be easily carried anywhere with minimal effort. The Pet Water Bottle is an innovative product invention which would allow pet owners to provide water for their thirsty companion when out for walks, or anytime while on-the-go. Convenient and portable, the Pet Water Bottle should be well received by the vast majority of pet owners, a very sizable market potential. The Pet Water Bottle is cost-effective to produce in the embodiments, as shown in FIGS. 1-4.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A portable water bottle drinking system for canines comprising:
(a) a hollow molded water bottle casing bisected longitudinally to form a front half and a back half,
wherein the hollow molded water bottle casing has an inside surface and an outside surface;
(b) one or more sets of hinges, wherein each set of hinges includes a male hinge and a female hinge,
wherein the male hinges are operably positioned on the outside surface of the front half so that they connect with the female hinges operably positioned on the outside surface of the back half to form a hinge set, and
wherein the front half and back half separate and open at the one or more hinge sets;
(c) one or more clasps, wherein each clasp contains a lock portion and a catch portion,
wherein the lock portion is operably positioned on the outside surface of the front half to cover the catch portion, and the catch portion is operably positioned on the outside surface of the back half to hold the lock portion in place when the clasps are in a closed position;
(c) at least two bottle pinches operably protruding into the inside surface of one of the halves wherein when looking into the interior surface when viewed from a plane parallel to the bisection of the two halves wherein the interior surface can be further bisected longitudinally into two a left and right halves, and
wherein at least one of the at least two bottle pinches is a left bottle pinch and is located in the left half of the clam shell and at least another of the at least two bottle pinches is a right bottle pinch and located in the right half of the clam shell, and
wherein the left and right bottle pinches both intersect with a horizontal plane that is orthogonal to the plane bisection of the two halves, and
wherein there is a horizontal gap between the left and right bottle pinches, and
wherein the left and right bottle pinches are configured to pinch a water bottle placed inside the casing when the clasps are in the closed position.

2. The portable water bottle drinking system for canines according to claim 1, wherein the hollow molded water bottle casing comprises a plastic material or a metal material or a plastic material and a metal material.

3. The portable water bottle drinking system for canines according to claim 1, wherein the hollow molded water bottle casing comprises a material that does not crack or warp when frozen.

4. The portable water bottle drinking system for canines according to claim 1, wherein there are two hinge sets.

5. The portable water bottle drinking system for canines according to claim 1, wherein there are two clasps.

6. The portable water bottle system for canines according to claim 1, further comprising:
a reusable water bottle having a removable lid,
wherein the reusable water bottle is shaped similarly to the hollow molded water bottle casing so that the reusable water bottle fits inside the hollow molded water bottle casing.

7. The portable water bottle drinking system for canines according to claim 6, wherein the reusable water bottle and the removable lid comprise a material that does not crack or warp when frozen.

8. A portable water bottle drinking system for canines according to claim 1,
wherein the hollow molded water bottle casing comprises a plastic material or a metal material or a plastic material and a metal material and
wherein the hollow molded water bottle casing comprises a material that does not crack or warp when frozen.

9. The portable water bottle drinking system for canines according to claim 1, further comprising two roll stops operably positioned on the back half to hold the back half in a stable manner when resting on a floor or other flat surface

10. The portable water bottle drinking system for canines according to claim 1, further comprising a textured grip, wherein the textured grip covers a middle section of the outside surface of the front half and the back half.

11. The portable water bottle drinking system for canines according to claim 1, further comprising a leash hole operably positioned on the back half to allow the molded water bottle casing to be carried on a leash.
